(19) United States
(12) Patent Application Publication
(10) Pub. No.: US 2018/0336273 A1
(43) Pub. Date: Nov. 22, 2018

(54) Verbal automated interpretation machine written interpreting viewer screen to be built in all sound system

(71) Applicant: William Bernard Christodolou, Carle Place L.I, NY (US)

(72) Inventor: William Bernard Christodolou, Carle Place L.I, NY (US)

(73) Assignee: William Bernard Christodolou, Carle Place, NY (US)

(21) Appl. No.: 15/731,299

(22) Filed: May 22, 2017

(51) Int. Cl. G06F 17/30; G10L 25/54

(52) U.S. Cl. CPC G06F 17/30743; G10H 1/0033; G10H 2240/141; G10L 25/54

(57) ABSTRACT

The main purpose of The Verbal Automated Interpreter and the Written Viewer Interpreter is to allow people to understand all that they hear in music and every word of what they listen too. Verbal Automated Interpreter will allow you punch into machine the musical piece and the machine will verbally feedback to the listener every word of the song. The point of this machine is for all musical lovers to understand every word to what their listening to. Meaning of the song and the album or track cover and artist's history The Written Viewer Interpreter works under the same concept as the verbal Automated Interpreter and the invention of it would appear in all new Sound systems and we are making it clear we are not taking any credit for inventing words on a screen as the invention but that sound systems that come out today have them built with these screens into them so that people are not left out in the dark and can have proper access to comprehend all music that they are listening to. With the inventiveness of The Verbal Automated Interpreter the listener will get verbal feed back of all the words of the music plus everything else said: Date music came out; Meaning of Track meaning of song; Artist; their history and any other facts that goes with the music. The Written Interpreting Viewing Screen will give same information and all systems made become equipped with this Interpretating Viewing Screen which will guarantee option for all people using them to always be able to comprehend the musical their listening too. This is my abstract Thank You William Christodolou

In the construction of all sound systems and even musical instruments various materials have been selected which offer a number of diverse properties, and allow for varied functions of these articles. These sound systems all stereo and other where musical sound comes from and instruments all brass and other and especially for keyboard piano and organ where musical sound are played from could be made from the insertion of reading screens that either give the listener word for word the music that is being played with title artist year and story line or gives the musicians artist title story line and year and the music they will play for all Keyboard Instrumental that the musicians will play right on a reading screen front of them. These reading screens can be made of alloys and elements suggested from wood acrylic plastic to rubber in places to metals with glass or plastic clear see through screens. Where an aesthetic appeal is necessary or desired these sound systems and instruments can be any one color or many attractive colors. The following list of properties servers to define possible uses for these sound systems instrument especially keyboard.

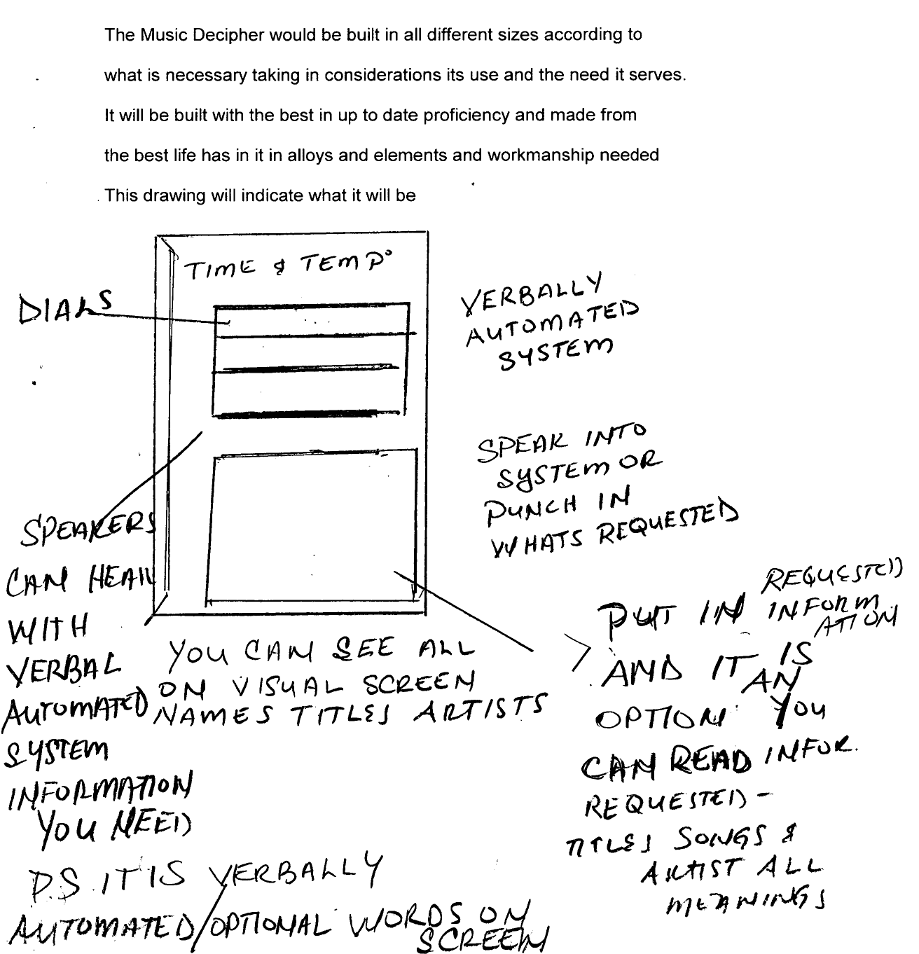

FIG. 1 displays a sound system with a musical reading screen. As you can see from the drawing the sound system is built with channels for station music and C.D. and album and now has the reading screen basically rectangular in size. In any and all sound systems that play music including all radios and music boxes people use to listen to music and are stationary or mobile. These screens that will be read from define all music that will be listened to and heard will be found in the center of the sound system. The musical reading screens could be above or below the stations and their band and able to be clearly read. These musical reading screens can be found also in between these bands of music. These screens will be clear plastic or glass and will be inserted into any and all sound system's framework whether it is wooden or metal or any and all alloys and elements that are needed to keep those reading screens firm and fixed in the system or on a separate window outside the system.

As far as the Keyboard Instruments and all other instruments as you can see by looking at FIG. 2 you will find these musical reading screens right in front of the musician as one plays their music they can read the music right off the music's reading screen. Another words when the musician sits down and plays the piano or organ they can look up and right in clear view and range the music that they will play and be playing will appear on the musical reading screen.

The screens will be in a frame work that is sturdy and will hold the screens that are spoken of and are attached to the piano and organ an all other instruments.

There will be additives such as brightness and clearness with strong colored letters to each word of the music on a background that is suitable and that will be in all sound systems and all instruments especially I stress all Keyboard Instruments. Thank You William Christodolou

For C.D. Players cassette 8-track or phonograph albums separately these reading viewing screens will appear in window of clear glass of strong clear plastic separately. If connected to sound system with station bands in between the bands when the radio stations are not playing but the album or C.D. etc etc. are playing then the reading screens will be read separately or directly from the sound system in between the two bards of radio stations. Also the optical feature strong colored letters to all the words of the music on colored back

1. The sound systems are all to have built into them Musical reading screens or a separate window that provides the words to all music played with title of piece year story line and artist and how long the piece is time wise.

2. All Keyboard musical Instruments built and constructed with musical reading screens built into them. Also all other musical instruments built with musical reading screens.

2a. Different size screens with detailed or simple decorated framework

3. Musical Reading screens will be built on top of or underneath the station bands or in between the station bands.

4. If it is a C.D. or album or even 8-tracks or cassette they will have the screen in the stereo or a separate screen or widow on the side or above the sound system that is equipped for C.D. album or cassette or 8-track systems.

5. The optical feature of the invention is the addition that these screens will be colorful with bright colored words seen through the reading screen with the proper colored background that helps illuminate the words of all music property.
